(19) United States
(12) Patent Application Publication
(10) Pub. No.: US 2004/0213973 A1
(43) Pub. Date: Oct. 28, 2004

(54) Film adhesive for sealing, film laminate for sealing and sealing method

(76) Inventors: Tomihiro Hara, Tokyo (JP); Shigeyoshi Ishii, Hatiouji-city (JP)

Correspondence Address: 3M INNOVATIVE PROPERTIES COMPANY, PO BOX 33427, ST. PAUL, MN, 55133-3427, US

(21) Appl. No.: 10/813,311

(22) Filed: Mar. 30, 2004

(30) Foreign Application Priority Data
Apr. 23, 2003 (JP) 2003-118862

(51) Int. Cl. B32B 31/00

(52) U.S. Cl. 428/212; 156/298

(57) ABSTRACT

A film adhesive for sealing a plurality of chip-type devices on a substrate at one time, including an adhesive layer of an adhesive composition which exhibits a minimum value of a storage modulus of elasticity before curing from 1×10³ to 5×10⁵ Pa measured by using a dynamic visco-elasticity measuring apparatus while elevating the temperature from 80° C. to 150° C. at an elevating temperature rate of 2.4° C./min and at a shearing rate of 6.28 rad/sec and a storage modulus of elasticity after curing from 5×10⁵ to 5×10⁷ Pa measured by using a dynamic visco-elasticity measuring apparatus at a sample temperature of 150° C. in a tensile mode at a measuring frequency of 6.28 rad/sec.

This application claims priority from Japanese Serial No. P.2003-118862, filed Apr. 23, 2003.

### TECHNICAL FIELD

The present invention relates to a film adhesive for sealing adapted to sealing a plurality of chip-type devices on a substrate at one time, to a film laminate for sealing and to a sealing method using them.

### PRIOR ART

At present, semiconductor devices have been sealed by bonding wires to semiconductor devices and to the lead terminals, sealing them with an epoxy resin sealing member, or by forming a pre-mold by integrally molding a lead frame in advance using a thermoplastic resin, mounting the semiconductor devices thereon, and placing and sealing a closure thereon with a sealing material. It is, however, considered that the future demand will be focused on the hollow semiconductor packages that can be favorably mounted on the highly integrated devices and that are suited for sealing surface elastic wave (SAW) devices and quartz devices. In order to more efficiently conduct the sealing operation, further, it is desired to carry out the packaging by sealing a plurality of chip-type devices on a substrate at one time.

As a hollow semiconductor package, Japanese Unexamined Patent Publication (Kokai) No. 2002-16466 discloses a method of producing an elastic surface wave device by arranging an active electrode on a substrate, comprising the steps of forming the active electrode on the substrate, forming a photoresist layer on the electrode, forming a first protection member having an opening, removing the photoresist from the opening of the first protection member, and closing the opening of the first protection member with a second protection member. This method requires many steps for forming a sealing structure with a hollow portion, causing the operation to become complex, and deteriorating the yield of work. In addition, a plurality of chip-type devices cannot be sealed at one time.

Japanese Unexamined Patent Publication (Kokai) No. 10-316955 discloses thermosetting adhesive composition that can be formed into a film adapted to the fabrication of IC packages, and a Japanese Unexamined Patent Publication (Kokai) No. 10-125825 discloses a sealed structure of a chip-type device, including a chip-type device flip-chip-mounted on a dielectric substrate by using bumps and a film-like sealing resin, and having a hollow portion at the surface of the chip-type device. When the film-like adhesive has pressure-sensitive adhesiveness, during the conveyance of the film the film-like adhesive adheres to the conveyer device and is peeled off with difficulty. At a subsequent step, the adhesive can adhere to the surface of the pressing machine during the hot-pressing which hinders the press from working normally. Besides, the inventions taught in these patents are for sealing only one chip-type device and not for sealing a plurality of chip-type devices.

Japanese Unexamined Patent Publication (Kokai) No. 2002-100945 discloses a method of producing elastic surface wave devices comprising the steps of arranging a plurality of elastic surface wave elements on an aggregate type substrate in a manner to form space therebetween, electrically connecting the electrodes of the elements to the conducting patterns of the aggregate type substrate, arranging a sealing member so as to cover the elastic surface wave elements except the hollow portion, and cutting the aggregate type substrate and the sealing member between the neighboring elastic surface wave devices thereby to produce a plurality of elastic surface wave devices. This method is capable of sealing the plurality of elastic surface wave devices at one time. According to this publication, the sealing is accomplished by uniformly applying a resin which is then cured by heating or by irradiation with an ultraviolet ray. The heating is effected or the ultraviolet ray is irradiated to enhance the viscosity of the resin so that, after being applied, the resin will not flow into space between the elastic surface wave elements and the substrate. However, since the liquid resin has been applied first, it is very difficult to suppress the fluidity. Further, the working is cumbersome using a first resin and a second resin as sealing members.

### PROBLEMS TO BE SOLVED BY THE INVENTION

It is an object of the present invention to provide a film adhesive for sealing capable of easily and efficiently sealing a plurality of chip-type devices, a film laminate for sealing and a method of sealing at one time.

### MEANS FOR SOLVING THE PROBLEMS

According to an embodiment of the present invention, there is provided a film adhesive for sealing a plurality of chip-type devices on a substrate at one time, including an adhesive layer of an adhesive composition which exhibits a minimum value of a storage modulus of elasticity before curing from 1×10³ to 5×10⁵ Pa measured by using a dynamic visco-elasticity measuring apparatus while elevating the temperature from 80° C. to 150° C. at an elevating temperature rate of 2.4° C./min and at a shearing rate of 6.28 rad/sec and a storage modulus of elasticity after curing from 5×10³ to 5×10⁵ Pa measured by using a dynamic visco-elasticity measuring apparatus at a sample temperature of 150° C. in a tensile mode at a measuring frequency of 6.28 rad/sec.

By controlling the composition, the film adhesive exhibits a suitable fluidity when heated and becomes capable of sealing chip-type devices having hollow portions. Owing to its film-like form, further, it can be used to easily seal a plurality of chip-type devices at one time with a high sealing work efficiency.

According to another embodiment of the present invention, there is provided a film laminate for sealing having a non-adhesive film on the above-mentioned film adhesive for sealing.

Owing to the non-adhesive film layer formed as an upper layer, the laminate makes it possible to easily handle the film and to easily conduct the sealing work without the film adheres to the conveyer device during processing.

### MODE FOR CARRYING OUT THE INVENTION

A preferred embodiment of the invention will now be described.

### A Film Adhesive for Sealing and a Laminate thereof

A film adhesive for sealing of the invention includes an adhesive layer that chiefly plays the role of sealing upon coming in contact with the chip-type devices and, in a preferred embodiment, is often a laminate having a non-adhesive film layer as an upper layer on the side of the adhesive layer opposite the chip-type devices. FIG. 1 is a sectional view illustrating an embodiment of a film laminate for sealing of the invention, and FIG. 2 is a flow diagram of illustrating a sealing method of the invention by using the film laminate for sealing. The film laminate 10 for sealing includes a lower adhesive layer 1 and an upper non-adhesive film layer 2. First, the film laminate 10 for sealing is arranged on a substrate 30 having a plurality of chip-type devices 20 in a manner that the adhesive layer 1 of the film laminate 10 for sealing comes in contact with the upper surfaces of the plurality of chip-type devices 20 (FIG. 2(a)). Then, the film laminate 10 is heated and press-adhered so as to be fluidized to encapsulate each of the plurality of the chip-type devices 20, and is cured to seal them at one time (FIG. 2(b)). Thereafter, the sealed chip-type devices 20 are singulated (FIG. 2 (c)). Thus, the film laminate for sealing of the invention efficiently seals the chip-type devices. Further, a film adhesive for sealing of the present invention can comprise a plurality of adhesive layers. An embodiment of a film laminate having a plurality of adhesive layers is illustrated in FIG. 3. It may be desirable that fluidity upon heating and melting of the outermost layer of the adhesive layers, i.e., the layer being contacted with a chip-type device is suppressed compared to inner layers. FIG. 3(a) shows a film laminate 10 having adhesive layers 1 consisting of two layers, the outermost layer 1″ and the inner layer 1′, the film laminate 10 being contacted with a chip-type device 20 disposed on a substrate 30. FIG. 3(b) shows the condition after the chips are sealed. Because fluidity upon heating and melting of the outermost layer 1″ is suppressed, the outermost layer 1″ will not flow into a hollow portion under the chip as shown in the drawing. On the other hand, the inner layer 1′ has higher fluidity and it can flow sufficiently to act as a sealing material such that formation of voids is minimized. Here, as described later, fluidity of the adhesive layer is expressed by its storage modulus of elasticity before curing. If such modulus is higher, fluidity upon heating is suppressed. Preferably, a storage modulus of elasticity before curing of the outermost adhesive layer is higher than those of inner adhesive layers, and more preferably, it is higher than those of the inner most adhesive layer, and particularly, higher than that of the innermost layer by no less than 0.2×10³ Pa.

### Adhesive Layer

The adhesive layer plays the role of sealing the chip-type devices having hollow portions. Therefore, the adhesive layer must have a suitable degree of fluidity at the time of heating and press-adhering so that the adhesive layer will not flow out excessively or so that the fluidity the adhesive layer will not become so low as to inhibit sealing. It is further required that the adhesive layer has a very low hygroscopic property so that it will not develop the foaming phenomenon in the film adhesive when it is heated and press-adhered. The adhesive layer must further have a heat resistance against high temperatures because it will be introduced into a solder reflow furnace. From the standpoint of working efficiency, further, it is desired that the adhesive layer have a tack exhibiting an initial adhesion to the chip-type devices that are intended to be sealed. The film adhesive layer must have a sufficiently high thickness so as to offer a resin in amounts sufficient for the chips to be buried therein after the sealing. It is usually desired that the film adhesive layer have a thickness of not less than 1.5 times the height of the chip and, typically, have a thickness of from 50 to 700 μm.

The adhesive layer gives a suitable fluidity to the sealing film when it has a suitable degree of storage modulus of elasticity while being heated and fluidized. The adhesive composition constituting the adhesive layer melts and undergoes the curing reaction upon being heated. Usually, therefore, the modulus of elasticity of the adhesive composition at a given temperature may not show a fixed value since it is affected by the rate of temperature rise. Therefore, the storage modulus of elasticity of the adhesive composition is defined as described below. An uncured adhesive composition is used as a sample, and the storage modulus of elasticity of the sample is measured by using a dynamic visco-elasticity measuring apparatus while elevating the temperature of the sample from 80° C. to 150° C. at a rate of 2.4° C./min and at a shearing rate of 6.28 rad/sec. A minimum value of storage modulus of elasticity obtained on a chart (temperature vs. storage modulus of elasticity) is defined as “storage modulus of elasticity before curing of the adhesive composition”. The thus defined storage modulus of elasticity before curing of the adhesive composition is, usually, in a range of from 1×10³ to 5×10⁵ Pa and, preferably, from 1×10⁴ to 1×10⁵ Pa. When the storage modulus of elasticity before curing is too small, the effect of the adhesive to inhibit too much fluidity when it is heated and press-adhered is lowered. When the storage modulus of elasticity before curing is too large, on the other hand, the adhesive may be poorly adhered when it is heated and press-adhered.

Next, the adhesive composition after curing, i.e., after it is used as a sample, and the storage modulus of elasticity of the sample is measured by using the dynamic visco-elasticity measuring apparatus at a sample temperature of 150° C. in a tensile mode at a measuring frequency of 6.28 rad/sec. A storage modulus of elasticity at 150° C. obtained on the chart (temperature vs. storage modulus of elasticity) is defined as “storage modulus of elasticity after curing of the adhesive composition”. The value is, usually, in a range of from 5×10^{5 to} 5×10⁷ Pa and, preferably, from 8×10⁵ to 1×10⁷ Pa. When the storage modulus of elasticity after curing is too small, the adhesive layer peels or swells and may not be capable of maintaining the intimate adhesion to a sufficient degree when it is exposed to high temperatures of not less than 200° C. and above in the step of solder reflow after having been sealed. When the storage modulus of elasticity after curing is too large, on the other hand, cracks may develop due to a small stress relaxation when the temperature is returned back to room temperature from the step of solder reflow conducted at high temperatures after the sealing.

As the adhesive composition having the above properties, there can be exemplified a reactive hot-melt adhesive composition comprising a thermosetting resin component and thermoplastic component. The thermosetting component and the thermoplastic component can be present as a mixture of separate compounds or the thermosetting component and the thermoplastic component can be present in one molecule. For example, a reactive hot-melt adhesive composition may comprise a mixture of a thermosetting polymer having thermosetting units and a thermoplastic polymer having thermoplastic units, or a copolymer having both thermosetting units and thermoplastic units, or a combination thereof. For example, a reactive hot-melt adhesive composition comprises a mixture of a polymer having epoxy-group containing monomeric units and a polymer having vinyl-group containing monomeric units, or a copolymer having both epoxy-group containing monomeric units and vinyl-group containing monomeric units.

A reactive hot-melt adhesive composition comprising the above polymer(s) or copolymer(s), as it is, may typically have a too low storage modulus of elasticity before curing. Therefore, a polymer which constitutes a hot melt adhesive composition may be incorporated with cross-linking structures in order to suppress fluidity of the composition when heated. For example, the above polymers or copolymers can be subjected with electron irradiation thereby being cross-linked. Alternatively, the polymer or copolymer can be cross-linked by a photo-polymerization of a precursor of a reactive hot-melt adhesive composition comprising a cationic polymerization catalyst in addition to the above polymer or copolymer, using a radiation such as ultraviolet radiation.

Preferably, a reactive hot-melt adhesive composition contained in the adhesive layer further comprises a rosin. Rosin does not yield by-products such as water harmful to electronics parts, in reaction with thermosetting component, particularly in reaction with epoxy group. A reactive hot-melt adhesive composition typically comprises 10 to 95% by weight of a thermosetting resin, 4 to 80% by weight of a thermoplastic resin and 1 to 20% by weight of a rosin.

Next, a film adhesive for sealing and a film laminate for sealing of the present invention will be explained in more details using a case with a polymer comprising vinyl-group containing monomeric units (thermoplastic component) and epoxy-group containing monomeric units (thermosetting component) (For example, a mixture of polymers containing the above two types of units, respectively, or a copolymer comprising both of the above two types of units). As a first example, the above polymer having been cross-linked by electron radiation is used as a polymer for an adhesive layer. Further, as a second example, the polymer having been cross-linked by photo-polymerization of a reactive hot-melt adhesive composition precursor comprising a cationic polymerization catalyst in addition to the above polymer is used as a polymer for an adhesive layer.

In the first example, the adhesive composition is, for example, a thermosetting adhesive composition containing (a) an ethylene-glycidyl(meth)acrylate copolymer, (b) an ethylene-alkyl(meth)acrylate copolymer, and (c) a rosin having a carboxyl group in the molecule, and having a crosslinking structure formed among the ethylene units of the above copolymer molecule. The adhesive composition can be produced by (1) preparing a precursor of the adhesive composition by mixing the ethylene-glycidyl(meth)acrylate copolymer (a), the ethylene-alkyl(meth)acrylate copolymer (b) and the rosin (c) in a manner that the whole components are mixed together substantially homogeneously, and (2) irradiating the precursor with an electron ray to form a crosslinking structure. Upon incorporating a filler in an amount of from 0 to 70% by mass, further, the foaming due to hygroscopic gases is suppressed.

As an adhesive composition that is particularly preferably used for the adhesive layer used in the invention, a thermosetting adhesive composition containing (a) the ethylene-glycidyl(meth)acrylate copolymer, (b) the ethylene-alkyl(meth)acrylate copolymer, and (c) the rosin having a carboxyl group in the molecules, and having a crosslinking structure formed among the ethylene units of the copolymer molecule is described more specifically. The thermosetting resin composition remains solid at normal temperature and can be heated and press-adhered to accomplish the sealing within a short period such as from 1 to 60 seconds and, preferably, from 5 to 20 seconds at a temperature of from 130 to 200° C. and, preferably, from 140 to 160° C. under a pressure of from 10 to 300 N/cm² and, preferably, from 30 to 100 N/cm². In this specification, the word “normal temperature” means about 25° C.

The thermosetting reaction is substantially a reaction between the “epoxy group” of the ethylene-glycidyl(meth)acrylate copolymer (copolymer (a)) and the “carboxyl group” of the rosin having carboxyl groups in the molecules thereof (rosin (c)), which does not produce any reaction side product such as water, and does not adversely affect the devices that are sealed.

The precursor of the adhesive composition melts at a low temperature (e.g., not higher than 120° C.) as compared to ordinary hot-melt adhesives and can be easily hot-melt-coated. When hot-melted, further, the precursor of the adhesive composition exhibits a relatively high fluidity, and can be formed like a coating or a film without requiring any solvent. Here, the “precursor” means the state of the composition before the intermolecular crosslinking is formed by the irradiation with an electron ray.

The intermolecular crosslinking is formed among the ethylene units in any one of: (1) the molecules of the ethylene-alkyl(meth)acrylate copolymer (copolymer (b)), (2) the molecules of the copolymer (a), or (3) the molecules of the copolymer (b) and the copolymer (a). The crosslinking reaction among the molecules proceeds among the ethylene units as the ethylene units in the molecules of the copolymer (a) and/or the copolymer (b) are radically activated by the irradiation with the electron ray.

The crosslinking structure enhances the modulus of elasticity of the adhesive composition when it is heated and press-adhered. Due to the improvement in the modulus of elasticity, the layer of the adhesive composition is not excessively fluidized when being heated and press-adhered, preventing the adhesive composition from flowing out and effectively preventing the thickness of the layer of the sealing material from becoming too small.

The curing reaction between the copolymer (a) and the rosin (c) is very mild at the heating temperature at the time of melt-coating or extrusion molding; the precursor of the adhesive composition is not gelled and its viscosity (complex modulus of elasticity) does not rise to a level that makes it difficult to continuously produce the film laminate. When the temperature is lower than 90° C., further, the curing reaction does not substantially proceed, and the storage stability of the adhesive composition can be enhanced. On the other hand, the curing reaction quickly proceeds when the temperature is not less than 130° C. and, preferably, not less than 150° C., and the time for the sealing work can be easily shortened.

The adhesive composition can be produced by molding the precursor of the adhesive composition into a film, and irradiating the molded film with an electron ray to form a crosslinking structure among the molecules of the copolymer. Though there is no particular limitation, the irradiation with the electron ray is usually conducted with an acceleration voltage in a range of from 150 to 500 keV and with a dosage usually in a range of from 10 to 400 kGy. When the crosslinking structure of the copolymer is formed by the irradiation with an electron ray under such conditions, the effect of forming the crosslinking by the irradiation with the electron ray may not deeply extend depending upon the thickness of the adhesive layer. Accordingly, the film of the adhesive composition is formed in a plurality of layers (e.g., maintaining a thickness of 100 μm per layer), the films are irradiated with the electron ray, respectively, and are then laminated to form a homogeneous crosslinking structure of the copolymer that constitutes the adhesive layer, so that the adhesive composition exhibits a constant modulus of elasticity (fluidity when heated). Or, depending upon the case, it maybe desired that the adhesive layer includes a plurality of layers of adhesive compositions having different moduli of elasticity. When, for example, it is desired to form a structure having a hollow portion like the elastic surface wave device (SAW device) or a quartz device, the modulus of elasticity of the outermost layer (i.e., layer coming in contact with the chip-type devices) is increased in the film laminate for sealing in order to suppress the fluidity of the outermost adhesive layer when being heated and press-adhered and to suppress the adhesive (sealing member) from flowing into the hollow portions. Preferably, a storage modulus of elasticity before curing of the outermost layer is higher than those of the inner layer, and more preferably higher than that of the innermost layer by no less than 0.2×10³ Pa.

### Ethylene-glycidyl(meth)acrylate Copolymer (copolymer (a))

When the adhesive composition is heated at a predetermined temperature, the ethylene-glycidyl(meth)acrylate copolymer (often called “copolymer (a)”) undergoes the curing reaction with the rosin (c) to enhance the cohesive force of the cured product. Such a highly cohesive force is advantageous for improving the peel preventing performance of the sealing member. Upon being irradiated with the electron ray, further, the crosslinking structure is formed among the molecules of the copolymer (a) and/or among the molecules of the copolymer (b), enhancing the modulus of elasticity of the adhesive composition of when it is being heated and press-adhered.

The copolymer (a) further works to allow melting of the precursor of the adhesive composition at a relatively low temperature to facilitate the melt coating. It further imparts a favorable heat-adhering property to the adhesive composition. The “heat-adhering property” means the adhering property to a material to be adhered in a stage of being cooled and solidified after the adhesive composition is melted and is intimately adhered to the material that is to be adhered.

The copolymer (a) is obtained by, for example, polymerizing, as a starting monomer, a monomer mixture comprising, for example, (i) a glycidyl(meth)acrylate monomer and (ii) an ethylene monomer. To the extent the advantage of the present invention is not impaired, there can be used, in addition to the above monomers, a third monomer such as propylene, alkyl(meth)acrylate or vinyl acetate. In this case, the number of carbon atoms of the alkyl group in the alkyl(meth)acrylate is usually from 1 to 8. Examples of the copolymer (a) include a bicopolymer of glycidyl(meth)acrylate and ethylene, a tercopolymer of glycidyl(meth)acrylate, vinyl acetate and ethylene, and tercopolymer of glycidyl(meth)acrylate, ethylene and alkyl(meth)acrylate.

The above copolymer (a) contains a recurring unit obtained by polymerizing a monomer mixture of glycidyl(meth)acrylate and ethylene, usually, in an amount of not less than 50% by weight and, preferably, not less than 75% by weight per the whole polymer. Further, the weight ratio (G:E) of the glycidyl(meth)acrylate (G) and the ethylene (E) in the above recurring unit is, preferably, in a range of from 50:50 to 1:99 and, particularly preferably, from 20:80 to 5:95. When the content of ethylene is too small, the compatibility of the copolymer (a) to the copolymer (b) and the rosin (c) decreases, making it difficult to obtain a homogeneous composition and, further, making it difficult to accomplish crosslinking with an electron ray. When the content of ethylene is too large, on the other hand, the adhering property may decrease. The copolymer (a) can be used as a single type of copolymer or as a mixture of two or more types of coploymers.

The melt flow rate (hereinafter often abbreviated as “MFR”) of the copolymer (a) measured at 190° C. is usually not less than 1 (g/lo min.). The adhesive composition can be heat-adhered when the MFR is not less than 1. Desirably, however, the MFR is not less than 150 to facilitate the melt coating of the precursor of the adhesive composition. When the MFR is too large, however, the cohesive force of the cured composition may decrease. From these points of view, the MFR is, particularly, preferably, in a range of from 200 to 1000.

Here, the “MFR” is a value measured in compliance with the stipulation of JIS K 6760. Further, the weight average molecular weight of the copolymer (a) is so selected that the MFR lies within the above range.

The copolymer (a) is contained in the adhesive composition usually at a ratio of from 10 to 95% by weight. When the ratio is less than 10% by weight, the cohesive force of the cured product is not enhanced. When the ratio exceeds 95% by weight, on the other hand, the adhering force of the sealing member may decrease at the time of heating and press-adhesion. From such points of view, the ratio is preferably, in a range of from 30 to 88% by weight and, particularly preferably, from 40 to 85% by weight.

### Ethylene-alkyl(meth)acrylate Copolymer (copolymer (b))

The ethylene-alkyl(meth)acrylate copolymer (“copolymer (b)”) works to melt the precursor of the adhesive composition at relatively low temperature, to facilitate the melt-coating and to enhance the heat-adhering property of the adhesive composition. By being irradiated with an electron ray, further, the copolymer (b) works to form a crosslinking structure among the molecules of the copolymer (b) and/or among the molecules of the copolymer (a), thereby to enhance the modulus of elasticity of the adhesive composition at the time of heating and press-adhesion. Further, the copolymer (b) has a lower water absorbing property than the copolymer (a) and, hence, works to enhance the water resistance of the adhesive composition or the precursor thereof. Generally, further, the copolymer (b) has a softening point lower than that of the copolymer (a). Therefore, when the cured composition is subjected to the heat cycle, the copolymer (b) works to relax the internal stress and to enhance the adhering property.

The copolymer (b) is obtained by, for example, polymerizing, as a starting monomer, a monomer mixture comprising, for example, an alkyl(meth)acrylate monomer and an ethylene monomer. To the extent the advantage of the present invention is not impaired, there can be used, in addition to the above monomers, a third monomer such as propylene, vinyl acetate or the like.

The starting monomer of the copolymer (b) does not contain the copolymerizable monomer having an epoxy group. To the extent the effect of the invention is not impaired, the above starting monomer may contain a copolymerizable monomer having a carboxyl group or a functional group of a carboxylic anhydride. Preferably, however, the starting monomer does not substantially contain these functional groups. Then, there takes place no thermosetting reaction between the copolymer (a) and the copolymer (b), making it very easy to prevent the gelling of the composition and undesired increase in the viscosity in the step of molding the film.

The number of carbon atoms of the alkyl group in the alkyl(meth)acrylate is, preferably, in a range of from 1 to 4. When the number of carbon atoms of the alkyl group exceeds 4, the modulus of elasticity of the composition after crosslinking may not be enhanced.

Examples of the copolymer (b) include a bicopolymer of alkyl(meth)acrylate and ethylene, and a tercopolymer of alkyl(meth)acrylate, vinyl acetate and ethylene. The above copolymer (b) contains a recurring unit obtained by polymerizing a monomer mixture of alkyl(meth)acrylate and ethylene, usually, in an amount of not less than 50% by weight and, preferably, not less than 75% by weight per the whole polymer.

The weight ratio (A:E) of the ethyl(meth)acrylate (A) and the ethylene (E) in the above recurring unit is, preferably, in a range of from 60:40 to 1:99 and, particularly preferably, from 50:50 to 5:95. When the content of ethylene is too small, the modulus of elasticity is not much improved by the electron ray crosslinking. When the content of ethylene is too great, on the other hand, the adhering property may decrease. The copolymer (b) can be used as a single type of copolymer or as a mixture of two or more types of copolymer.

The MFR of the copolymer (b) measured at 190° C. is usually not less than 1, preferably, not less than 150 and, particularly preferably, in a range of from 200 to 1000 on account of the same reasons as that of the case of the copolymer (a). The weight average molecular weight of the copolymer (b) is so selected that the MFR lies within the above range.

The copolymer (b) is contained in the adhesive composition usually at a ratio of from 4 to 80% by weight. When the ratio is smaller than 4% by weight, the coating property of the precursor and the heat-adhering property of the adhesive composition may decrease and, additionally, it becomes difficult to form the crosslinking with an electron ray. When the ratio exceeds 80% by weight, on the other hand, the thermosetting property of the composition may decrease. From such points of view, the ratio is preferably in a range of from 10 to 60% by weight and, particularly preferably, from 15 to 50% by weight.

### Rosin having a Carboxyl Group in the Molecule (Rosin (c))

The rosin (hereinafter often referred to as “rosin (c)”) used as a starting material of the adhesive composition has a carboxyl group, reacts with the copolymer (a) in the thermosetting operation, and thermally cures the adhesive composition so as to enhance the adhering property. Examples of rosin (c) include gum rosin, wood rosin, tall oil rosin, or rosins obtained by chemically modifying these rosins (e.g., polymerized rosin).

The acid value of the rosin (c) is, preferably, from 100 to 300 and, particularly preferably, from 150 to 250. When the acid value is too low, the reactivity with the polymer (a) decreases and the composition is less cured. When the acid value is too high, on the other hand, stability (effect for preventing an increase in the viscosity) may be impaired at the time of heat-molding. Here, the “acid value” is represented by the amount (milligrams) of potassium hydroxide that is needed for neutralizing one gram of the sample.

The rosin (c) has a softening point which is, preferably, 50 to 200° C. and, particularly preferably, from 70 to 150° C. When the softening point is too low, the rosin (c) reacts with the copolymer (a) during storage to deteriorate the storage stability. When the softening point is too high, on the other hand, the reactivity with the copolymer (a) drops and the composition may be less cured. Here, the “softening point” means a value measured in compliance with JIS K 6730.

The rosin (c) is contained in the adhesive composition usually at a ratio of from 1 to 20% by weight. When the ratio is less than 1% by weight, the curing property and the heat-adhering property of the composition may decrease. When the ratio exceeds 20% by weight, on the other hand, the adhering property of the composition after curing may decrease. From the above point of view, the ratio is, preferably, in a range of from 2 to 15% by weight and, particularly preferably, from 3 to 10% by weight.

The rosin (c) can be used as a single type or as a mixture of two or more types. To the extent the advantage of the invention is not impaired, it is also allowable to use in combination a rosin without substantially having carboxyl group.

Next, the second example will be explained. A main difference between the first example and the second example is that a photo-cationic polymerization catalyst is used for forming a cross-linked structure in the second example, while electron beam irradiation is used for forming a cross-linked structure in the first example. Therefore, the adhesive composition of the second example can be obtained in the same way as that of the first example, except a procedure for formation of a cross-linked structure.

In the second example, the adhesive composition is, for example, a photo-polymerized product of an adhesive composition precursor comprising a photo-cationic polymerization catalyst with a mixture of a polymer having an epoxy-group containing monomeric unit and a polymer having a vinyl-group containing monomeric unit, or with a copolymer having both an epoxy-group containing monomeric unit and a vinyl-group containing monomeric unit.

An epoxy-group containing monomer is, for example, an epoxy-group containing compound which can be copolymerized with a vinyl-group containing monomer. Specifically, unstaturated carboxylic acid glycidyl esters such as glycidyl acrylate, glycidyl methacrylate, glycidyl itaconate, and unsaturated glycidyl ethers such as allyl glycidyl ether, methallyl glycidyl ether, styrene-p-glycidyl ether are preferred, and particularly, glycidyl acrylate and glycidyl methacrylate are preferred.

A vinyl-group containing monomer is a vinyl compound having no epoxy group. Specifically, α-olefins such as ethylene, propylene, 1-butene, 4-methyl-1-pentene, 1-hexene, 1-heptene, 1-octene, 1-nonene and 1-decene, aromatic vinyl compounds such as styrene, α-methyl styrene and divinyl benzene, conjugated diene compounds such as butadiene and isoprene, acrylonitrile and vinyl chloride etc. may be mentioned. Further, a vinyl-group containing monomer can be an unsaturated ester compound other than the above-described unsaturated carboxylic acid glycidyl esters. Specifically, saturated carboxylic acid vinyl esters such as vinyl acetate, vinyl propionate and vinyl butyrate, unsaturated carboxylic acid alkyl esters such as methyl acrylate, ethyl acrylate, butyl acrylate, methyl methacrylate, ethyl methacrylate and butyl methacrylate etc. can be exemplified. Among them, vinyl acetate, methyl acrylate, ethyl acrylate and methyl methacrylate are preferred.

More specifically, the adhesive composition is, for example, a photo-polymerized product of an adhesive composition precursor comprising, a polyethylenic copolymer having an epoxy group in the molecule (for example, ethylene-glycidyl (meth)acrylate copolymer (a) as described in the first example), a thermoplastic polymer having no epoxy group (for example, ethylene-alkyl(meth)acrylate copolymer (b) as described in the first example), and further comprising a photo-cationic polymerization catalyst. In addition, the precursor may further comprise a rosin having carboxyl group (c) as described in the above first example.

### Cationic Polymerization Catalyst

A cationic polymerization catalyst is a compound which, upon irradiated with ultraviolet ray, forms cationic active species such as Louis acid to catalyze a ring-opening reaction of epoxy ring. Specific examples of a cationic polymerization catalyst include, for example, fluoro-boric complexes and organometallic complex salts, consisting of a metallic cation such as a cation of iron, chromium, molybdenum, tungsten, manganese, rhenium, ruthenium, osmium, etc., and a ligand such as cyclopentadienyl anion, indenyl anion, (xylene)hexafluoroantimonate anion, hexafluorophospate anion, etc. The content of the cationic polymerization catalyst is typically in the range of 0.01 to 10 percent by weight, based on the total weight of the adhesive composition.

The irradiation dosage of ultraviolet ray for cross-linking the precursor by ultraviolet ray is a sufficient amount so that the storage modulus of elasticity before curing of the adhesive composition is within the range as described above and the fluidity of the adhesive composition is appropriately controlled. The cross-linking reaction proceeds by an opening reaction of an epoxy ring as described above. However, some of the epoxy groups must not react so that the adhesive composition of the present invention retains sufficient thermosetting property after irradiation of ultraviolet ray. Irradiation dosage of ultraviolet ray is typically, although not limited to, 100 to 10,000 mJ/cm² (integrated value at 360 nm).

### Other Components

The adhesive composition can contain a variety of additives. Such additives may be antioxidants such as phenol-type or amine-type primary antioxidants, or phosphor-type or sulfur-type secondary antioxidants, ultraviolet-ray absorbing agents, fillers (inorganic filler, electrically conducting particles, pigment, etc.), lubricants such as wax, rubber components, tackifying agents, crosslinking agents and cure-promoting agents.

### Non-adhesive Film Layer

When the adhesive layer has a tack (pressure-sensitive adhesiveness), the non-adhesive film layer prevents the adhesive layer from adhering to the conveyance devices that are being used to convey the film. The non-adhesive film layer that exhibits the above function must have heat resistance since it is exposed to high temperatures at the time of being heated and press-adhered. Besides, the chip-type devices themselves must be capable of withstanding high temperatures and high humidities like those of Pressure Cracker Testing (PCT testing: IEC68-2-68) which is an acceleration testing. Accordingly, the film constituting the non-adhesive film layer must have corrosion resistance as well as moisture resistance including the properties such that the film is not deformed or discolored and not cracked even when it is folded. When the plurality of chip-type devices, after having been sealed, are cut into individual chips, the film layer must be made so as to not develop burrs at the cut surfaces. It is further desired that the film layer is not wrinkled or curled, thereby enabling the film laminate and the chip-type devices to be favorably positioned.

In addition, the non-adhesive film layer may often work as a protection layer preventing the infiltration of moisture into the chip-type devices that are sealed. Here, to prevent the moisture from infiltrating into the chip-type devices, it is desired that the film constituting the non-adhesive film layer have a low hygroscopic property and a high resistance to the permeation of moisture. It is further desired that the film have a high heat conducting property so that heat can be dissipiated from the sealed devices.

By taking the above properties into consideration, the non-adhesive film layer may be, for example, a plastic film such as of polyimide, crystalline polymer, polyphenylene sulfide or polyetherimide, or a laminate of the above plastic film and a metal foil such as of copper, stainless steel, chrome steel, nickel or aluminum, or the above plastic film on which the above metal is vapor-deposited. Though there is no particular limitation, the thickness of the non-adhesive film layer is, usually, from 10 to 100 μm in the case of a plastic film, 10 to 100 μm/1 to 50 μm in the case of the plastic film/metal foil, and 10 to 100 μm/0.03 to 0.3 μm in the case of the plastic film/metal-vapor-deposited film.

### Preparation of the Film Laminate for Sealing

The film laminate for sealing is prepared in a manner, for example, as described below. First, a precursor of an adhesive composition containing the copolymer (a), the copolymer (b) and the rosin (c) is prepared in case of the first example. In case of the second example, a precursor is prepared by adding a cationic polymerization catalyst to a mixture comprising the copolymer (a), copolymer (b) and preferably rosin (c). Next, a peel liner such as a polyethylene terephthalate (PET) film is melt-coated with the precursor to form a film of the precursor. Next, the film-like precursor is irradiated with an electron or ultraviolet ray to form a crosslinking structure among the molecules of the copolymers to form an adhesive layer. The obtained adhesive layer and the non-adhesive film are stuck together and are heat-laminated to prepare a film laminate for sealing of the present invention. When it is desired to prepare a film laminate having a plurality of adhesive layers, the adhesive layer formed on the peel liner is peeled off the peel liner, a plurality of adhesive layers are overlaid thereon and, then, the non-adhesive film is overlaid followed by the heat-lamination, thereby to obtain the film laminate for sealing having the plurality of adhesive layers. When the plurality of adhesive layers are formed, the conditions for the electron or ultraviolet ray irradiation may be varied to form adhesive layers having different storage moduli of elasticity.

The precursor of the above composition is prepared, usually, by mixing the components that are the starting materials by using a kneader or a mixer until they become substantially homogeneous. As the device of this kind, there can be used a kneader, a roll mill, an extruder, a planetary mixer or a homo-mixer. The temperature and time for mixing are so selected that the reaction of epoxy group, for example, reaction of the copolymer (a) and the rosin (c) will not substantially proceed, and, usually, a temperature range is from 20 to 120° C., and the time is from 1 minute to 2 hours.

The melt-coating is conducted, usually, at a temperature in a range of from 60 to 120° C. The coating is formed by using an ordinary application means such as a knife coater or a die coater. In the first example, the electron ray is irradiated by using an electron ray accelerator usually at an acceleration voltage over a range of from 150 to 500 keV with a dosage of usually in a range of from 10 to 400 kGy. In the second example, the ultraviolet ray is irradiated usually at 100 to 10,000 mJ/cm². Finally, one adhering surface or both adhering surfaces of the film adhesive are protected with a liner to obtain a product. When the adhesiveness of the adhering surfaces is relatively low, the film adhesive may not need to be protected with the liner.

### Step Conditions

When a plurality of chip-type devices are to be sealed at one time with the film adhesive for sealing, there is employed a heating and press-adhering system by which the film adhesive is heated and press-adhered so as to be cured. The heating and press-adhering conditions (temperature at which the adhesive itself is heated) are usually such that the temperature is in a range of from 130 to 200° C. and, preferably, from 140 to 160° C. The time is usually in a range of from 1 to 60 seconds and, preferably, from 5 to 20 seconds. The pressure is in a range of, usually, from 10 to 300 N/cm² and, preferably, from 30 to 100 N/cm². The temperature is the effective temperature applied to the adhesive, and the time is the one required until the temperature reaches the effective temperature. The heating and press-adhering conditions must be so set that the film adhesive is intimately adhered to the base substrate to a sufficient degree by taking the heat resistances of the base substrate and of the chip-type devices into consideration. When the temperature exceeds 200° C., however, the base substrate may be thermally deteriorated. When the temperature is not higher than 130° C., the film adhesive is not fluidized to a sufficient degree and fails to encapsulate.

After being heated and press-adhered, the film adhesive is cured in the oven. Here, the temperature condition for curing is usually from 130 to 180° C. and, preferably, from 140 to 170° C. The curing time is usually from 0.5 to 5 hours and, preferably, from 1 to 3 hours. The curing condition must be so set that the adhesive is cured to a sufficient degree by taking the heat resistance of the film adhesive into consideration. When left to stand at an effective temperature of not lower than 180° C. for extended periods of time, however, the adhesive and the base substrate may be deteriorated. The curing condition varies depending upon the specifications of the oven; i.e., a curing time is necessary at an effective temperature required for curing the adhesive.

### Use

The film laminate for sealing of the invention is used for sealing a plurality of chip-type devices on a substrate at one time. The chip-type devices can be used for sealing either the active parts such as integrated circuits or passive parts such as elastic surface wave devices (SAW devices) or quarts devices. The fluidity of the adhesive layer can be controlled to lie in a desired range as described above with reference to the adhesive composition. It is therefore allowed to effect the sealing without permitting the sealing member to be dripping in the applications where the devices being sealed have hollow structures. Therefore, the film laminate for sealing of the invention is particularly useful for the applications where it is required to form a hollow structure as represented by elastic surface wave devices (SAW devices) such as SAW filter, SAW oscillator, SAW resonator, SAW delay elements (SAW sensor, SAW convolver), as well as quartz devices such as quartz filter, quartz oscillator, quartz resonator, quartz vibrator and quartz sensor.

### EXAMPLES 1 TO 9 AND COMPARATIVE EXAMPLES 1 AND 2

### EXAMPLES 1 AND 2

### Film Adhesive

The film adhesive was formed in a manner as described below. Namely, CG5001/NUC6570/KE604=65/35/3.5 (parts by weight) were mixed together to form an adhesive composition. The CG5001 was an ethylene-glycidyl methacrylate copolymer (copolymer (a))(MFR=350 g/10 min, ethylene unit:glycidyl methacrylate unit (weight ratio)=82:18, Bond-Fast (trade name) of Sumitomo Kogaku Kogyo Co.). The NUC6570 was an ethylene-ethyl acrylate copolymer (copolymer (b))(MFR=250 g/10 min, ethylene unit:ethyl acrylate unit (weight ratio=75:25, produced by Nihon Unicar Co.)), and the KE604 was a rosin (acid value of 242, Pine Crystal (trade name) manufactured by Arakawa Kagaku Kogyo Co.).

By using the kneader, first, the copolymer (b) and the rosin (c) were kneaded together at 110° C. for 10 minutes to form pellets of a substantially homogeneous mixture. Then, the pellets and the copolymer (a) were mixed together by using the same device as the one described above at 110° C. for 2 minutes such that all the components became substantially homogeneous, thereby to prepare a precursor.

The above precursor was applied onto a polyethylene terephthalate peel liner by the knife coating so as to form a film precursor having a thickness of 100 μm. The precursor was irradiated with an electron ray by using an accelerator of the linear filament type to form an adhesive layer. The electron ray was irradiated with an acceleration voltage of 200 kV and a dosage of 140 kGy. A sample of the film adhesive for sealing (Example 1) of the invention was thus obtained. Further, a sample of the film adhesive for sealing of the invention (Example 2) was obtained having a thickness of 300 μm by laminating, by heat lamination, two layers that were formed by using a film precursors having a thickness of 150 μm each. One layer was irradiated with an electron ray with an acceleration voltage of 200 kV and a dosage of 140 kGy. The other layer was irradiated with an acceleration voltage of 200 kV and a dosage of 170 kGy.

### EXAMPLES 3 AND 4

### Film Adhesive

An adhesive composition of this example is formed by mixing 70 parts by weight of an ethylene-glycidyl methacrylate copolymer (Bond-Fast (trade name) produced by Sumitomo Kogaku Kogyo Co.; MFR=350 g/10 min, ethylene unit:glycidyl methacrylate unit (weight ratio)=82:18), 29.5 parts by weight of an ethylene-ethyl acrylate copolymer (UNC-EEA 6070 (trade name) produced by Nihon Unicar Co.) and 0.5 parts by weight of a cationic polymerization catalyst (Ar₃SSBF₆, where Ar is an aromatic functionality) using kneader to make homogeneous mixture. Mixing operations were carried out under the conditions of 110° C. for 10 minutes.

Such adhesive composition was sandwiched between 2 PET films (releasable films) and passed through a gap of knifes heated to 140° C. to obtain a film-like precursor. 20 W/cm of high pressure mercury lamp was used to irradiate ultraviolet ray to this precursor from a position 20 cm apart from the precursor. Ultraviolet irradiations were effected at the dosage of 630 mJ/cm^{2 and} 1540 mJ/cm² to form film adhesives for sealing of the present invention (Examples 3 and 4, respectively).

### EXAMPLES 5 TO 9

### Film Laminates

The adhesive layers obtained as described above were arranged on the non-adhesive films identified below and were heat-laminated at 120° C. to obtain samples of the film laminates for sealing of the invention (Examples 5 to 9).

### EXAMPLE 5

### Example 1/polyimide (PI, Thickness of 50 μm)

### EXAMPLE 6

### Example 1/Liquid Crystal Polymer (LCP, Thickness of 50 μm)

### EXAMPLE 7

### Example 1/Chrome Steel-Vaporized film/polyphenylele sulfide (Cr/PPS, Thickness of 0.2 μm/50 μm)

### EXAMPLE 8

### Example 2/Copper foil/polymide Laminate (Cu/PI, Thickness of 12 μm/50 μm)

### EXAMPLE 9

### Example 2/Stainless Steel Alone (SUS, Thickness of 50 μm)

### COMPARATIVE EXAMPLE 1

An epoxy type film adhesive (100 μm) comprising 40 parts by mass of an acrylic resin and 60 parts by mass of an epoxy component of a bisphenol A epoxy resin+dicyandiamide curing agent.

### COMPARATIVE EXAMPLE 2

A thermoplastic polyethylene film adhesive (100 μm).

The thus obtained adhesive layers were measured for their storage moduli of elasticity in a manner as described below. The adhesive compositions of Examples 1, 3 and 4 were measured for their storage moduli of elasticity. By using a dynamic viscosity measuring apparatus (Model RDA II) manufactured by Leo Metrix Co., the storage modulus of elasticity was measured while raising the temperature from 80° C. to 150° C. at a rate of 2.4° C./min and at a shearing rate of 6.28 rad/sec. The results were as shown in Table 1.

TABLE 1

| | Example 1 | Example 3 | Example 4 | Comp. Example 1 | Comp. Example 2 |
|---|---|---|---|---|---|
| | Storage mod. of | Storage mod. of | Storage mod. of | Storage mod. of | Storage mod. of |
| | elasticity | elasticity | elasticity | elasticity | elasticity |
| | before curing | before curing | before curing | before curing | before curing |
| Temp. (° C.) | (Pa) | (Pa) | (Pa) | (Pa) | (Pa) |
| 85 | 6 × 10⁴ | 7 × 10⁵ | 8 × 10⁵ | 6 × 10² | 3 × 10⁵ |
| 95 | 2 × 10⁴ | 4 × 10⁵ | 5 × 10⁵ | 2 × 10² | 1 × 10⁵ |
| 105 | 2 × 10⁴ | 3 × 10⁵ | 4 × 10⁵ | 1 × 10² | 8 × 10⁴ |
| 115 | 2 × 10⁴ | 2 × 10⁵ | 3 × 10⁵ | 1 × 10² (min. | 7 × 10⁴ |
| | | | | value) | |
| 125 | 1 × 10⁴ (min. | 1 × 10⁵ (min. | 2 × 10⁵ (min. | 2 × 10⁴ | 6 × 10⁴ |
| | value) | value) | value) | | |
| 135 | 1 × 10⁴ | 3 × 10⁵ | 4 × 10⁵ | 8 × 10⁵ | 5 × 10⁴ |
| 150 | 2 × 10⁴ | 5 × 10⁵ | 3 × 10⁶ | 6 × 10⁶ | 5 × 10⁴ (min. |
| | | | | | value) |

Next, cured adhesive layers were obtained by introducing the obtained adhesive layers into an oven maintained at 150° C. and curing them for 2 hours, and were then measured for their storage modulus of elasticity as described below. The adhesive compositions were measured for their storage modulus of elasticity. By using a dynamic viscosity measuring apparatus (Model RSA) manufactured by Leo Metrix Co., the storage modulus of elasticity was measured at 150° C. in a tensile mode at a measuring frequency of 6.28 rad/sec. The results are as shown in Table 2.

TABLE 2

| | Example 1 | Example 3 | Example 4 | Comp. Example 1 | Comp. Example 2 |
|---|---|---|---|---|---|
| | Storage mod. of | Storage mod. of | Storage mod. of | Storage mod. of | Storage mod. of |
| | elasticity after | elasticity after | elasticity after | elasticity after | elasticity after |
| Temp. (° C.) | curing (Pa) | curing (Pa) | curing (Pa) | curing (Pa) | curing (Pa) |
| 150 | 1.1 × 10⁶ | 0.8 × 10⁶ | 2.0 × 10⁶ | 2.1 × 10⁶ | could not be |
| | | | | | measured |
| | | | | | (smaller than |
| | | | | | 0.8 × 10⁵) |

The samples of Examples 1 to 9 and Comparative Examples 1 and 2 were tested in a manner as described below.

### Testing Method

1. Storage modulus of elasticity before curing.

⊙—1×10³ to 5×10⁵ Pa

X—lies outside the range of 1×10³ to 5×10⁵ Pa

2. Reflow resistance.

As a sample, there was used a stainless steel plate (30 mm long×30 mm wide×0.6 mm thick)/a film adhesive (15 mm, square) or a laminate (15 mm, square) of a stainless steel plate/a film adhesive/a non-adhesive film. After press-adhered under 150° C.×50 N/cm²×10 seconds, the sample was cured at 150° C.×2 hours, and was left to stand in an environment of 85° C./85% RH for 96 hours. Then, the sample was placed on a hot plate heated at 230° C. to make sure for 120 seconds whether there occurred a popcorn phenomenon.

⊙—no popcorn phenomenon occurred at less than 120 seconds.

X—popcorn phenomenon occurred within 30 seconds.

3. Prevention of adhesion to the conveyer device.

Vacuum pick was adsorbed and was released. N number=10.

Evaluation of the results.

⊙—could be released 10 times without sticking to the adsorption pad.

603 —could be released 7 to 9 times without sticking to the adsorption pad.

The test results of Examples 1 to 9 and Comparative Examples 1 and 2 are as shown in Table 3 below.

TABLE 3

| | Example 1 | Example 2 | | | | | | | | | Comp. |
|---|---|---|---|---|---|---|---|---|---|---|---|
| | This | This | | | | | | | | Comp. | Ex. 2 |
| | invention | invention | | | Example 5 | Example 6 | Example 7 | Example 8 | Example 9 | Ex. 1 | Poly- |
| | (100) | (300) | Example 3 | Example 4 | PI | LCP | Cr/PPS | Cu/PI | SUS | Expoxy | ethylene |
| Storage | ⊙ | ⊚ | ⊙ | ⊙ | ⊙ | ⊙ | ⊙ | ⊙ | ⊙ | X | ⊙ |
| modulus of elasticity | | | | | | | | | | | |
| before curing | | | | | | | | | | | |
| Reflow | ⊙ | ⊙ | ⊙ | ⊙ | ⊙ | ⊙ | ⊙ | ⊙ | ⊙ | X | X |
| resistance | | | | | | | | | | | |
| Prevention of | ◯ | ◯ | ◯ | ◯ | ⊙ | ⊙ | ⊙ | ⊙ | ⊙ | ◯ | ◯ |
| adhesion to | | | | | | | | | | | |
| conveyer device | | | | | | | | | | | |

### EXAMPLE 1

### Film Adhesive of the Invention wherein the Precursor (100 μm) was Irradiated with 140 kGy

### EXAMPLE 2

### Film Adhesive of the Invention Obtained by Laminating the Layer Formed by Irradiating a Precursor (150 μm) with 140 kGy and a Layer Formed by Irradiating a Precursor (150 μm) with 170 kGy

### EXAMPLE 3

### Film Adhesive of the Invention wherein the Precursor (100 μm) was Irradiated with 630 mJ/cm² of Ultraviolet Ray

### EXAMPLE 4

### Film Adhesive of the Invention wherein the Precursor (100 μm) was Irradiated with 1540 mJ/cm² of Ultraviolet Ray

### EXAMPLE 5

### Example 1/Polyimide (PI, Thickness of 50 μm)

### EXAMPLE 6

### Example 1/Liquid Crystal Polymer (LCP, Thickness of 50 μm)

### EXAMPLE 7

### Example 1/Chrome Steel-Vaporized film/polyphenylene sulfide (Cr/PPS, Thickness of 0.2 μm/50 μm)

### EXAMPLE 8

### Example 2/Copper foil/polymide Laminate (C/PI, Thickness of 12 μm/50 μm)

### EXAMPLE 9

### Example 2/Stainless Steel Alone (SUS, Thickness of 50 μm)

### COMPARATIVE EXAMPLE 1

### An Epoxy Type Film Adhesive (100 μm), epoxy resin+dicyandiamide/acrylic resin=60/40

### COMPARATIVE EXAMPLE 2

### A polyethylene Film Adhesive (100 μm), polyethylene resin:100

It can be learned from the results of Table 3 that the film laminates for sealing of the present invention are favorably satisfying the requirements for sealing the chip-type devices.

### EFFECT OF THE INVENTION

The film laminate for sealing of the present invention is effective in sealing a plurality of chip-type devices.

### BRIEF DESCRIPTION OF THE DRAWINGS

FIG. 1 is a sectional view illustrating an embodiment of a film laminate for sealing of the present invention.

FIG. 2 is a diagram illustrating the steps of a sealing method by using the film laminate for sealing of the present invention.

FIG. 3 is a set of cross-sectional views illustrating a film laminate for sealing having a plurality of layers of the present invention and the condition after chips are sealed.

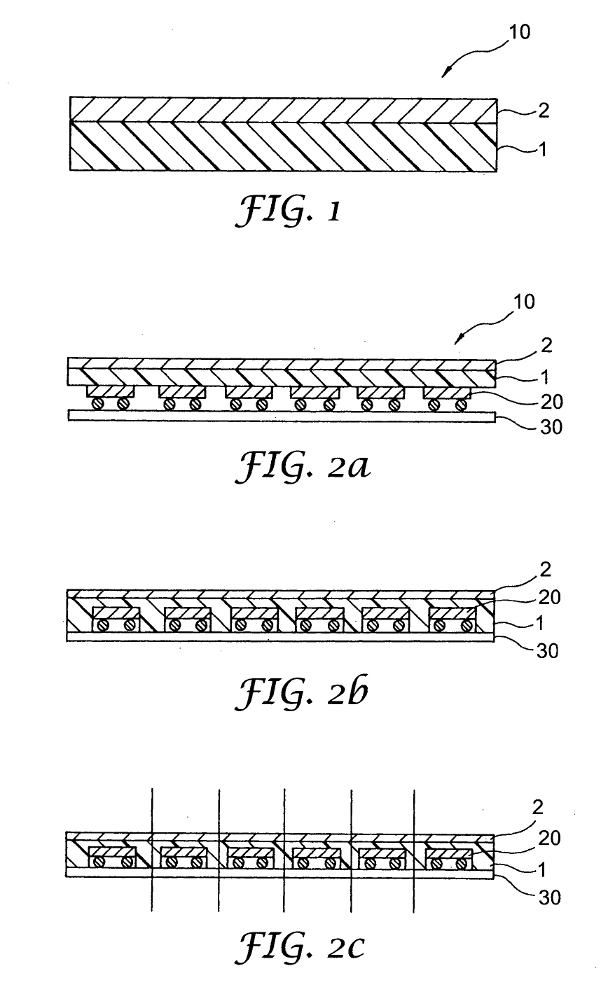

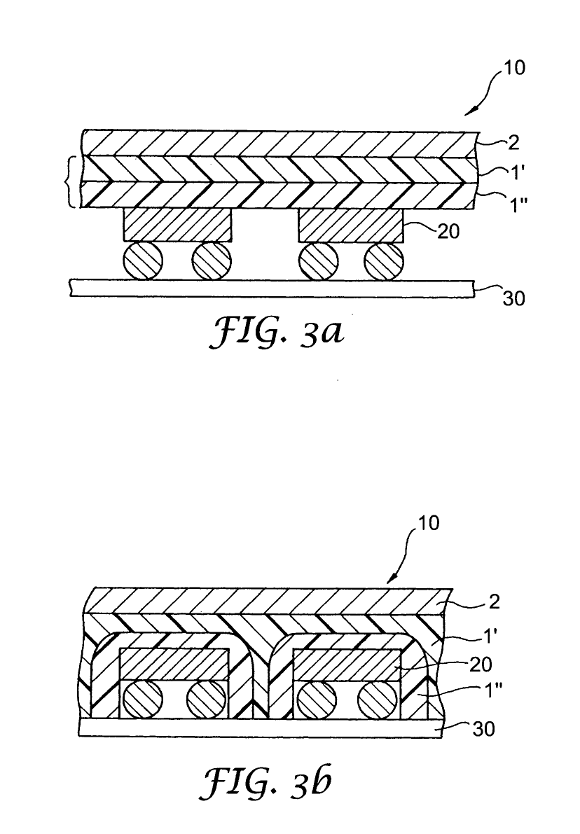

### DESCRIPTION OF REFERENCE NUMERALS

1—lower adhesive layer

2—upper non-adhesive film layer

10—film laminate for sealing

20—chip-type devices

30—substrate

What is claimed is:

1. A film adhesive for sealing a plurality of chip-type devices on a substrate at one time, including an adhesive layer of an adhesive composition which exhibits a minimum value of a storage modulus of elasticity before curing from 1×10³ to 5×10⁵ Pa measured by using a dynamic visco-elasticity measuring apparatus while elevating the temperature from 80° C. to 150° C. at an elevating temperature rate of 2.4° C./min and at a shearing rate of 6.28 rad/sec and a storage modulus of elasticity after curing from 5×10⁵ to 5×10⁷ Pa measured by using a dynamic visco-elasticity measuring apparatus at a sample temperature of 150° C. in a tensile mode at a measuring frequency of 6.28 rad/sec.

2. A film adhesive for sealing according to claim 1, wherein said adhesive layer includes a plurality of layers, and the outermost layer of said layers, which is in contact with the chip-type devices has a storage modulus of elasticity before curing that is higher than those of the inner layers.

3. A film adhesive for sealing according to claim 2, wherein the outermost layer has a storage modulus of elasticity before curing that is higher than that of the innermost layer by at least 0.2×10³ Pa.

4. A film adhesive for sealing according to claim 1, wherein the adhesive composition used for said adhesive layer is a reactive hot-melt adhesive composition comprising a thermosetting resin component and a thermoplastic resin component.

5. A film adhesive for sealing according to claim 4, wherein the reactive hot-melt adhesive composition comprises a mixture of a polymer comprising a vinyl group-containing monomeric unit and a polymer comprising an epoxy group-containing monomeric unit, or a copolymer comprising vinyl group-containing monomeric unit and an epoxy group-containing monomeric unit.

6. A film adhesive for sealing according to claim 4, wherein a fluidity of the reactive hot-melt adhesive composition is controlled by incorporation of a cross-linking structure in the polymer compound.

7. A film adhesive for sealing according to claim 6, wherein the polymer or copolymer of the reactive hot-melt adhesive composition is cross-linked by an electron beam.

8. A film adhesive for sealing according to claim 6, wherein the reactive hot-melt adhesive composition is one in which a precursor comprising a photo-cationic polymerization catalyst is photo-polymerized with the polymer or copolymer.

9. A film adhesive for sealing according to claim 8, wherein said photo-polymerization is effected by irradiation of ultraviolet ray.

10. A film adhesive for sealing according to claim 4, wherein the reactive hot-melt adhesive composition further comprises a rosin.

11. A film adhesive for sealing according to claim 4, wherein the adhesive composition comprises from 10 to 95% by mass of a thermosetting resin, from 4 to 80% by mass of a thermoplastic resin, and from 1 to 20% by mass of a rosin.

12. A film laminate for sealing having a non-adhesive film on a film adhesive for sealing of any claim 1.

13. A method of sealing chip-type devices, comprising the steps of:
1) arranging an adhesive layer of a film adhesive for sealing or a film laminate for sealing of claim 1 to be contacted with the upper surfaces of a plurality of chip-type devices on a substrate having said plurality of chip-type devices; and
2) heating and press-adhering said film adhesive or laminate, and curing the film adhesive to seal said plurality of chip-type devices at one time.

14. A sealing method according to claim 13, further comprising a step of singulating after said plurality of chip-type devices have been sealed.
